(19) United States
(12) Patent Application Publication
(10) Pub. No.: US 2024/0232118 A9
(43) Pub. Date: Jul. 11, 2024

(54) DIGITAL IMAGE STORAGE DEVICE FOR VEHICLE

(71) Applicants: Gun Ho YOON, Seoul (KR); Dabonda Universe Inc., Seoul (KR)

(72) Inventor: Young Gyun LIM, Seoul (KR)

(73) Assignees: Gun Ho YOON, Seoul (KR); Dabonda Universe Inc., Seoul (KR)

(21) Appl. No.: 18/269,316

(22) PCT Filed: Jun. 21, 2021
(86) PCT No.: PCT/KR2021/007773

§ 371 Date: Jun. 23, 2023

(30) Foreign Application Priority Data
Dec. 24, 2020 (KR) 10-2020-0183007

(51) Int. Cl. G06F 13/40; H04M 1/72409

(52) U.S. Cl. CPC G06F 13/4081; H04M 1/724098

(57) ABSTRACT

Provided is a vehicular digital image storage device including a housing, a PCB substrate positioned inside the housing and installed with an SD card receiving part where an SD card is inserted, a shutter mechanism, and a control circuit unit installed on the PCB substrate and including a transmission/reception unit for transmitting and receiving signals to and from an external device, wherein when a password is inputted from the external device, the control circuit unit is configured to control the shutter mechanism to open the shutter mechanism to allow the SD card contained in the SD card receiving part to be ejected or allow the SD card to be inserted into the SD card receiving part, thereby operating the vehicle image storage device using an external device such as a smartphone so as to eject the SD card inserted therein.

### TECHNICAL FIELD

The present invention relates to a digital image storage device for a vehicle, and more particularly, to a digital image storage device for a vehicle to prevent an unauthorized person from illegally and arbitrarily removing an SD card inserted therein.

### BACKGROUND ART

A vehicular digital image storage device is generally known as a black box. In the present invention, the terms “vehicular digital image storage device” and “black box” are used interchangeably.

Recently, as cities develop, the complexity of traffic increases day by day, and accordingly the incidence of traffic accidents caused by vehicles has increased year by year.

Vehicular digital image storage devices, so-called black boxes, are widely used to identify causes of accidents by recording and storing situations of the accidents, which occur during the driving of vehicles, as video digital data. The various situations that occur during the operation of vehicles are converted into digital video data, and stored in a secure digital (SD) card that is detachably inserted into the black box.

The various situations which occur while the vehicle is driving such as accidents or the like occurring outside the vehicle may be stored in the SD card of the vehicular digital image storage device as image data, and conversations and videos occurring inside the vehicle and related to privacy may also be stored as data.

However, the SD card inserted in the digital image storage device may be sometimes ejected and separated from the digital image storage device due to the accident and thus necessary video may fail to be recorded and saved.

In addition, a person who is not allowed to watch the video or listen to the conversation recorded in the SD card may separate the SD card from the digital image storage device and watch the video or listen to the conversation without permission, thereby causing a risk of infringement of privacy.

Korean Patent Registration No. 10-1870675 discloses a device that prevents the SD card from being detached from the digital image recording device and failing to record a necessary image, under the title of “BLACK BOX WITH PROTECTION FOR BREAKING CARD DATA”.

According to the black box disclosed in Korean Patent Registration No. 10-1870675, a card mounting unit is provided inside a black box housing, an insertion part into which an SD card is inserted is provided to be connected to the card mounting unit, and a knob is installed to cover at least one upper side of the SD card inserted in the insertion part of the black box housing so as to prevent the SD card from being removed.

In the Korean Patent Registration No. 10-1870675, the knob has a structure installed to be slidable outside the black box housing, having one side provided inside the black box housing, integrally installed to be connected to a switch for controlling a storage of the SD card to actuate the switch upon the operation of the knob, formed with elastic pressing protrusions separated into at least two portions, and press-fitted and fixed through a mounting hole formed provided in the black box housing, so that the SD card is prevented from being separated.

Videos or conversations stored in the separated SD card may be played back, viewed or heard using another device, such as a PC or smartphone, even without the black box.

Therefore, in terms of privacy, it is getting more important to prevent a person who is not allowed to watch images or listen to conversations stored in the SD card from arbitrarily separating the SD card from the image storage device.

A vehicular digital image storage device, which has an SD card slot closed by a shutter mechanism but opened when a password matches to operate the shutter mechanism, has been developed by the inventor and registered as Korean Patent Registration No. 10-2077328.

Korean Patent Registration No. 10-2077328 is configured to operate a shutter of the shutter mechanism when an inputted password matches a password stored therein.

The device is configured such that the password is inputted using a display unit formed of a touch screen on a rear side of the black box. Accordingly, in order to remove the SD card, the black box is required to be actuated before removal, and the SD card cannot be removed from the black box while the black box is not actuated.

### DISCLOSURE OF INVENTION

### Technical Problem

An object of the present invention is to provide a vehicular digital image storage device for allowing a password to be entered using an external device as a mobile communication device such as a smartphone without entering the password by using the touch screen on the rear side of the black box so as to solve the problem that the stored image data is damaged at the time when the SD card is removed from the black box.

### Solution to Problem

The vehicular digital image storage device to achieve the above object includes: a housing having a groove formed on one side of the vehicular digital image storage device; a PCB substrate positioned inside the housing and installed thereon with an SD card receiving part installed such that an inlet of the SD card receiving part is exposed through the groove so that an SD card is inserted thereto; a shutter mechanism installed in the groove of the housing to open and close the inlet for the SD card receiving part; a control circuit unit installed on the PCB substrate and including a transmission/reception unit for transmitting and receiving signals to and from an external device, wherein the control circuit unit controls the shutter mechanism to open the shutter mechanism when a password is inputted from the external device, so as to allow the SD card contained in the SD card receiving part to be ejected or allow the SD card to be inserted into the SD card receiving part.

In the above configuration, the shutter mechanism is configured to include: a motor attached to the PCB substrate; a worm gear attached to a shaft of the motor; a shutter having a rack engaged with the worm gear, wherein, when the motor is driven, the rack of the shutter is moved up and down by the worm gear to open the inlet for the SD card receiving part, so as to allow the SD card to be ejected from or inserted to the SD card receiving part.

In the above configuration, the motor is operated and opens the inlet for the SD card receiving part when a password stored in the image storage device matches a password inputted by an external smartphone so as to allow the SD card to be ejected from or inserted to the SD card receiving part.

In the above configuration, the password may be inputted using the external smartphone to drive the motor.

### Advantageous Effects of Invention

According to the present invention, the inlet for the SD card is always closed by the shutter mechanism operated by the drive motor, and the drive motor is driven only when the password entered by the user matches, so that the SD card can be prevented from being separated from the digital image storage device even upon the accident.

In addition, a person prohibited to watch the video or listen to the conversation recorded in the SD card cannot separate the SD card from the digital image storage device, so that the privacy can be ensured. In particular, according to the present invention, the password can be entered using a mobile communication device such as a smartphone without using a touch screen on the rear side of the black box, so that the SD card can be separated from the black box even when the black box is not actuated.

### BRIEF DESCRIPTION OF DRAWINGS

FIG. 1 is a perspective view according to the present invention.

FIG. 2 is a rear perspective view from a rear side of FIG. 1.

FIG. 3 is a left side view according to the present invention.

FIG. 4 is a left side view showing an opened state of a shutter according to the present invention.

FIG. 5 is a perspective view showing a shutter mechanism attached to a PCB substrate.

FIG. 6 is a perspective view showing a shutter installed with a rack.

FIG. 7 is a plan view showing a state in which the shutter is operated to close an inlet for an SD card receiving part.

FIG. 8 is a plan view showing a state in which the shutter mechanism opens the inlet for the SD card receiving part.

FIG. 9 is a configuration diagram of a circuit installed in a PCB substrate.

FIG. 10 is a diagram illustrating a page of an application installed in a screen of black box or a smartphone.

FIG. 11 is a flowchart showing the operation of the control unit.

FIG. 12 is a diagram showing a page for inputting an ID installed in the screen of black box or the smartphone.

### BEST MODE FOR CARRYING OUT THE INVENTION

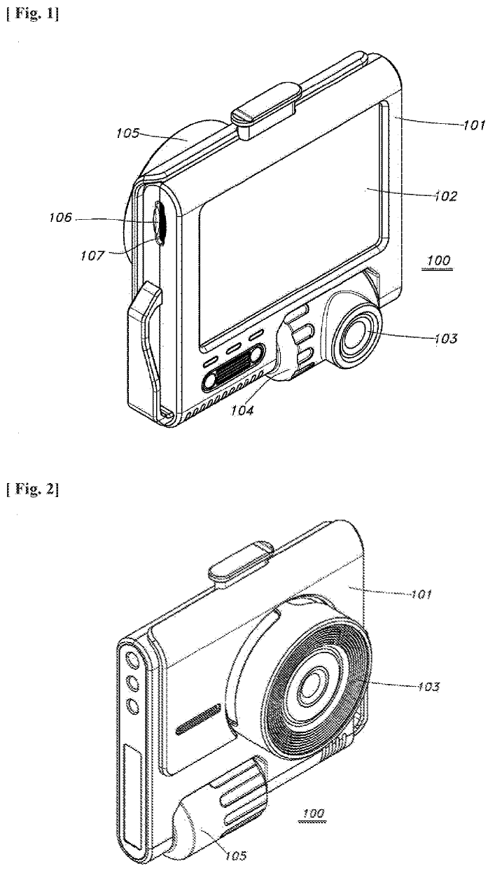

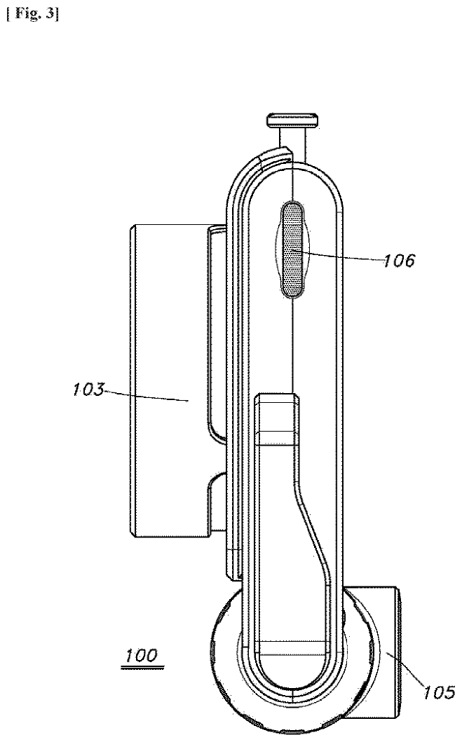

First, FIGS. 1 and 2 show a vehicular image storage device 100. The vehicular image storage device 100 is formed with a body part 101 having a rectangular parallelepiped shape to accommodate a circuit board therein, a front camera 105 capable of capturing a front image is installed in a front of the body part 101, and a rear camera 103 capable of capturing a rear image is provided at a lower side of the body part. The rear camera 103 is installed on a click-shaped direction control part 104 rotatable with respect to the body part 101.

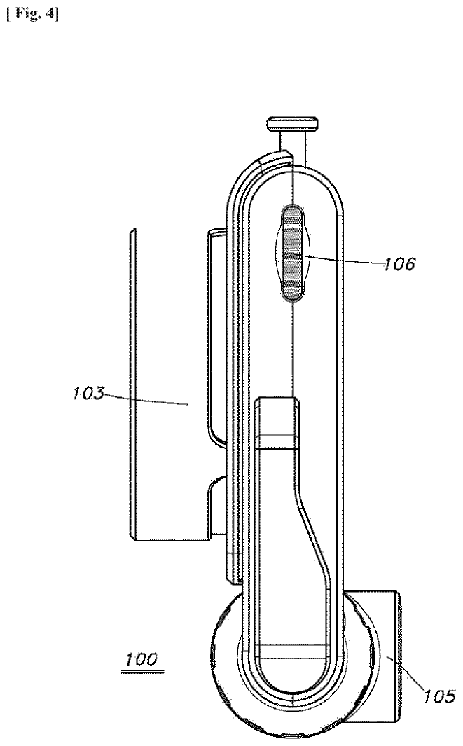

A screen 102 for displaying stored images is provided on a rear side of the vehicular image storage device 100. A menu screen 301 is displayed on the screen 102 to manipulate the vehicular image storage device 100 as shown in FIG. 4, so that the menu screen may be touched to set necessary functions. Accordingly, the screen 102 is configured to set the necessary functions or allow a password to be inputted through the screen.

FIG. 3 is a left side view according to the present invention.

The vehicular image storage device 100 is formed on a left side thereof with a groove 106 into which an SD card is inserted, and a shutter 107 of a shutter mechanism is installed in the groove 106.

The shutter 107 of the shutter mechanism closes an inlet for an SD card receiving part 121 as shown in FIG. 3 or opens the inlet for the SD card receiving part 121 as shown in FIG. 4. When the inlet for the SD card receiving part 121 is opened, the inlet 121a for the SD card receiving part 121 is exposed as shown in FIG. 4, so that an SD card accommodated may be ejected from or inserted into the SD card receiving part 121 through the inlet 121a.

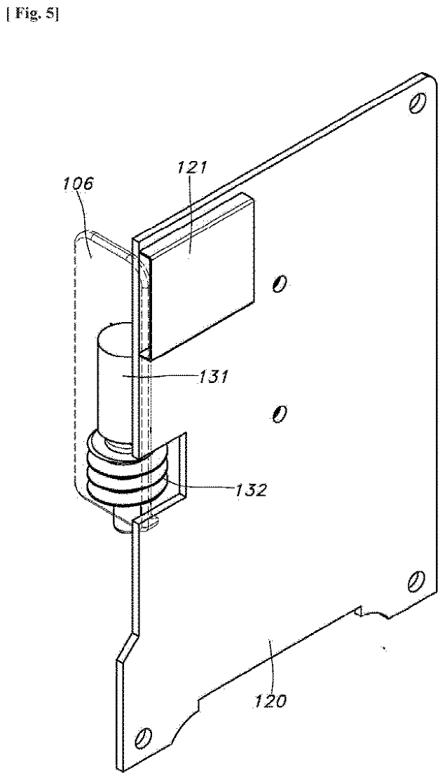

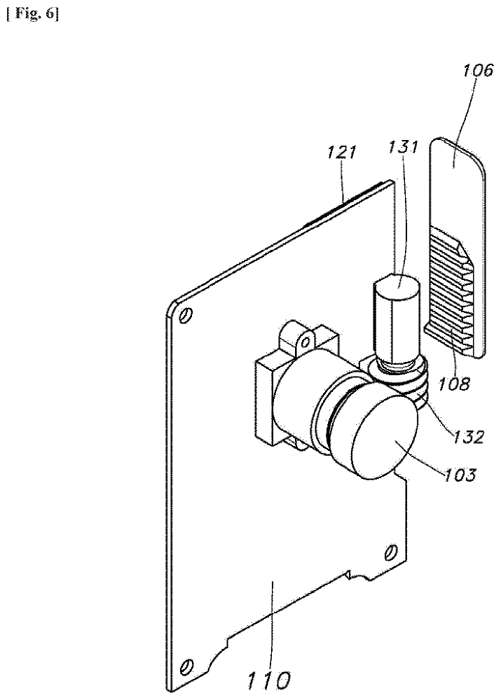

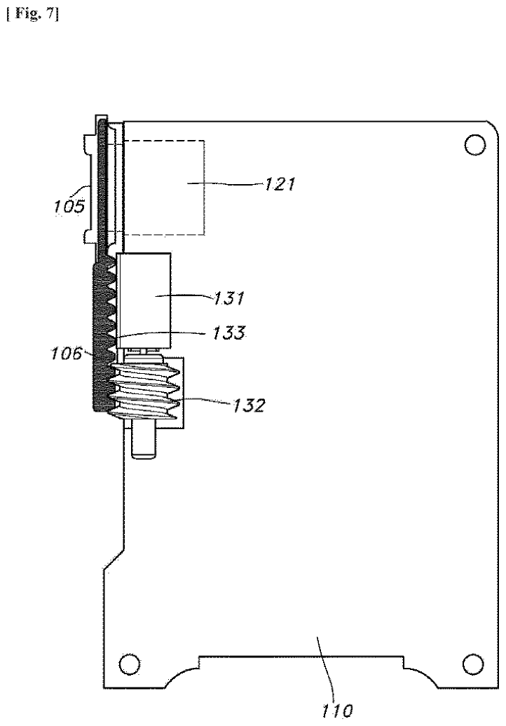

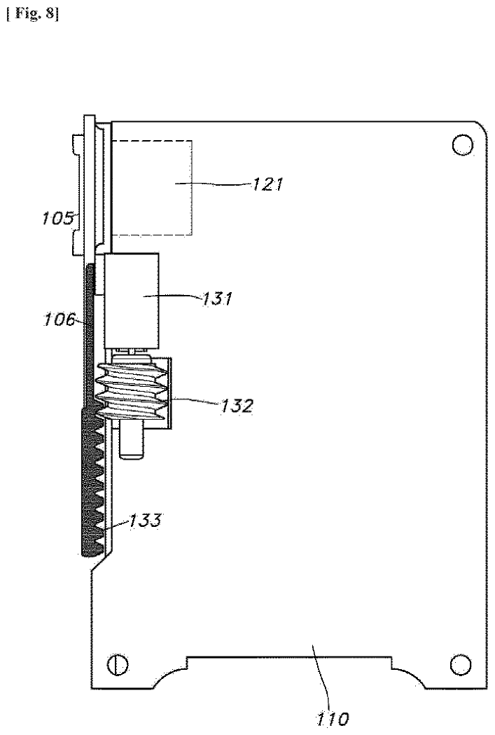

As shown in FIG. 5, the shutter 107 of the shutter mechanism is attached to a PCB substrate 120 and moved up and down by a motor 131 to which a worm gear 132 is attached.

A rack 132 engaged with the worm gear 132 is installed such that the shutter 106 may be moved when the worm gear 132 attached to the motor 131 is rotated. The SD card receiving part 121 is installed on a rear surface of the PCB substrate 110, and the inlet 121a for the SD card receiving part is installed so as to close or open the shutter 106.

A PCB board is positioned inside the vehicular image storage device 100, and an SD card receiving part 121 capable of receiving the SD card is attached to the PCB substrate. The inlet for the SD card receiving part 121 may be exposed to the outside through the groove 106.

The inlet 121a for the SD card receiving part 121 exposed through the groove 106 is configured such that the SD card inserted in the SD card receiving part 121 cannot be ejected when the shutter of the shutter mechanism is operated to close the inlet, and the SD card may be ejected from the SD card receiving part 121 when the inlet 121a for the SD card receiving part 121 is opened.

The shutter of the shutter mechanism is operated by the drive motor, and the drive motor is operated when a password stored therein matches password by a touch screen of the image storage device, or when a matching password is received from a smartphone.

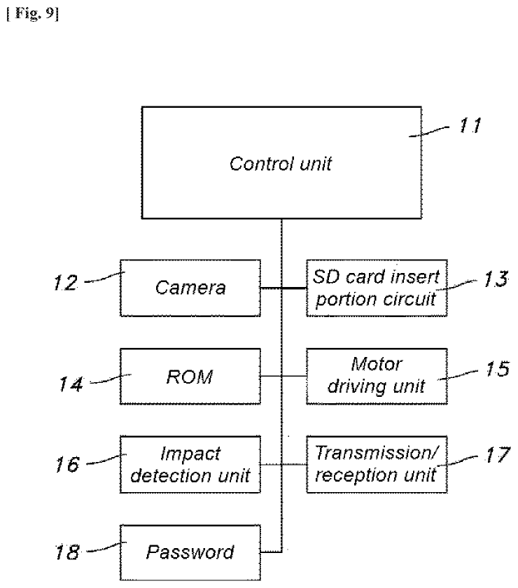

FIG. 9 is a configuration diagram of a circuit installed in the PCB substrate.

The control unit 11 is connected to a camera 12, an SD card insertion unit 13, a ROM 14 in which an operation control program is stored, a motor driving unit 15, an impact detection unit 16, and a transmission/reception unit 17, and a password storage unit 18 through a bus line. Front and rear images captured by the camera 12 are stored in the SD card 13 based on a program. The black box ID storage unit 18 stores a password for the corresponding black box required for determining a matching state from the touch screen or smartphone. When the black box is purchased, the password may be initially set and saved and a user may change the password as needed.

The image data stored in the SD card 13 is stored to prevent the image data from being deleted or overwritten in the SD card based on an impact strength of the impact detection unit 16.

The transmission/reception unit 17 serves to transmit/receive signals when an external device such as a smartphone attempts to open or close the shutter of the shutter mechanism.

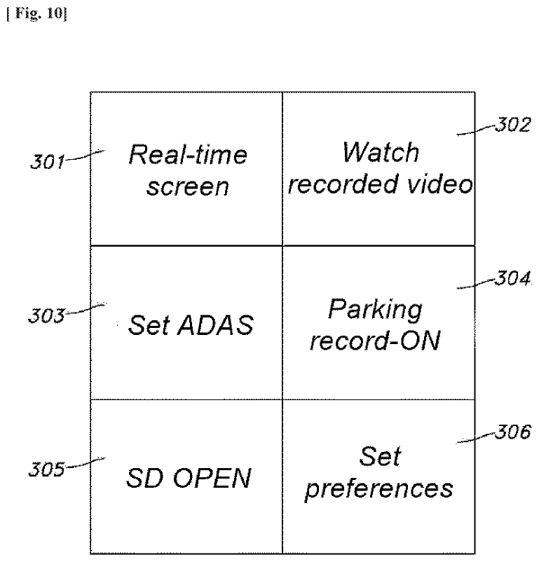

FIG. 10 is a diagram illustrating a page of an application installed in a screen of black box or a smartphone.

The touch screen of the black box and the screen installed in the smartphone have the same page of the application.

When the password stored in the password storage unit 18 in the black box matches the password inputted from the smartphone, and the “SD OPEN” is touched on a main initial page to eject the SD card, the shutter of the shutter mechanism is operated from a closed state to an opened state, so that the SD card may be in an opened state.

Even when a function of watching recorded videos is touched on the main page, the recorded video cannot be viewed when the password stored in the password storage unit 18 does not match the password inputted from the smartphone.

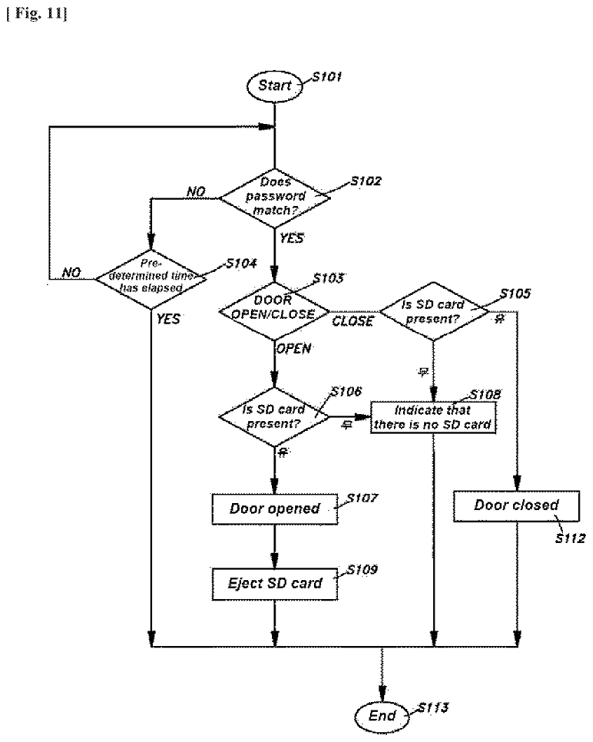

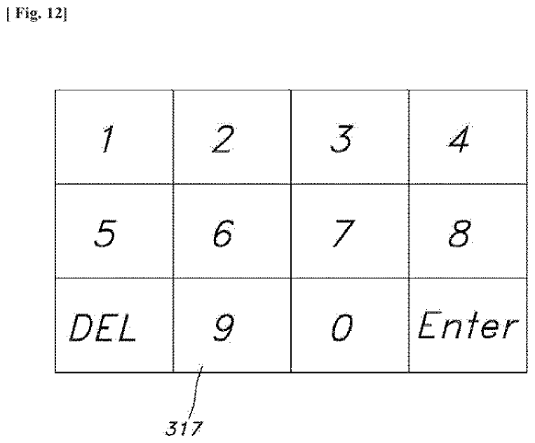

FIG. 11 is a flowchart showing the operation of the control unit.

When a button SD OPEN 305 is touched on the application page in FIG. 10, the operation starts in step S101. When the operation starts, step S102 proceeds to determine whether the password of the black box matches. When the password does not match in step S102, step S104 proceeds and awaits for a predetermined time until a correct password is inputted. When the predetermined time has not elapsed in step S104, the process returns to step S102 to determine whether the password of the black box matches.

When a predetermined time elapses in step S104, step S113 proceeds to finish the process.

When it is determined that the password matches in step S102, step S103 proceeds to determine whether the door is opened or closed.

When the door is opened in step S103, step S106 proceeds to determine whether the SD card is present.

When the SD card is present in step S106, step S107 proceeds to open the door, step S109 proceeds to eject the SD card, and step S113 proceeds to finish the operation. When the SD card is not present in step S106, step S108 proceeds to indicate that there is no SD card, and step S113 proceeds to finish the operation.

When the door is closed in step S103, step S105 proceeds to determine whether the SD card is present. When it is determined that the SD card is not present in step S105, step S108 proceeds to indicate that there is no SD card, and step S113 proceeds to finish the operation.

When the SD card is present in step S105, step S112 proceeds to close the door, and step S113 proceeds to finish the operation.

FIG. 12 is a diagram showing a page for inputting an ID installed in the screen of black box or the smartphone.

The password can be entered from the touch screen of black box or the smartphone.

Accordingly, a person prohibited to watch the video or listen to the conversation recorded in the SD card cannot separate the SD card from the digital image storage device, so that the privacy can be ensured. Particularly, according to the present invention, the password may be entered using a mobile communication device such as a smartphone without using a touch screen on the rear side of the black box, so that the SD card can be separated from the black box even when the black box is not operated.

1. A digital image storage device for a vehicle, the digital image storage device comprising: a housing having a groove formed on one side of the vehicle image storage device; a PCB substrate positioned inside the housing and installed thereon with an SD card receiving part installed such that an inlet of the SD card receiving part is exposed through the groove so that an SD card is inserted thereto; a shutter mechanism installed in the groove of the housing to open and close the inlet of the SD card receiving part; and a control circuit unit installed on the PCB substrate and including a transmission/reception unit for transmitting and receiving signals to and from an external device, wherein the control circuit unit controls the shutter mechanism to open the shutter mechanism when a password is inputted from the external device, so as to allow the SD card contained in the SD card receiving part to be ejected or allow the SD card to be inserted into the SD card receiving part.

2. The vehicle digital image storage device of claim 1, wherein the shutter mechanism includes: a motor attached to the PCB substrate; a worm gear attached to a shaft of the motor; and a shutter having a rack engaged with the worm gear, wherein the rack of the shutter is moved up and down by the worm gear to open the inlet of the SD card receiving part when the motor is driven, so that the SD card is ejected from or inserted to the SD card receiving part.

3. The vehicle digital image storage device of claim 2, wherein the motor is operated when a password stored in the image storage device matches a password inputted by an external smartphone.

4. The vehicle digital image storage device of claim 3, wherein the password is configured such that the motor is operated when the password stored in the image storage device matches the password inputted by the external smartphone.

5. The vehicle digital image storage device of claim 1, wherein an application installed in the external smartphone is identical to an application installed in a touch screen of the digital image storage device.
